(19) United States
(12) Patent Application Publication
(10) Pub. No.: US 2003/0213567 A1
(43) Pub. Date: Nov. 20, 2003

(54) Blind covering kit

(76) Inventor: Kevin Markley, Media, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/437,821

(22) Filed: May 14, 2003

Related U.S. Application Data
(60) Provisional application No. 60/380,801, filed on May 15, 2002.

(51) Int. Cl. E06B 3/06

(52) U.S. Cl. 160/236

(57) ABSTRACT

A covering kit for blinds includes a series of covers that attach over the slats of a blind. The covers are attached over the slats to convey a photograph, text or decorative image when the slats on the blind are closed. The covering kit may feature an image divided into a series of sections, with each section produced onto a template. In one embodiment of the present invention, the templates may be cut to form strips that are clipped over the slats on a Venetian blind. The strips may include one or more tabs configured to fold around a slat to support each strip on the blind. The strips may also include margins so that the image sections form a substantially continuous and uninterrupted image when the slats are closed.

### RELATED APPLICATIONS

This application claims the benefit of the filing date of U.S. Provisional Application No. 60/380,801 filed May 15, 2002, the entire disclosure of which is incorporated herein by reference.

### FIELD OF THE INVENTION

The present invention relates to accessories for blinds, and more particularly to covers that may be attached over the slats of a blind and arranged to collectively form a continuous image, photograph or text on the blind when the slats are closed.

### SUMMARY OF THE INVENTION

The present invention is a covering kit for blinds and a method for making a covering kit for blinds. Covers are attached over the slats on blinds to convey a photograph, text or decorative image when the slats on the blinds are closed. The covering kit may feature an image divided into a series of sections, with each section produced onto a template. In one embodiment of the present invention, the templates may be cut to form strips that are clipped over the slats on a Venetian blind. The strips may include one or more tabs configured to fold around a slat to support each strip on the blind. The strips may be aligned on the slats so that the image segments form a substantially continuous and uninterrupted image when the slats are closed.

### DESCRIPTION OF THE DRAWINGS

The foregoing summary as well as the following description will be better understood when read in conjunction with the figures in which:

FIG. 1 is a partial plan view of a covering kit installed on a blind in accordance with the present invention.

FIG. 2 is a side elevation view of a covering strip used in the kit shown in FIG. 1, wherein the strip is installed over a substantially flat slat in a blind.

FIG. 3 is a side elevation view of a covering strip used in the kit shown in FIG. 1, wherein the strip is installed over a curved slat in a blind.

FIG. 4 is an isometric view of a covering strip installed over a curved slat of a blind.

FIG. 5 is a partial isometric view of the covering kit installation of FIG. 1 mounted on a blind with curved slats.

FIG. 6 is an illustration of a template used in making the covering kit of FIG. 1.

### DETAILED DESCRIPTION OF THE PREFERRED EMBODIMENT

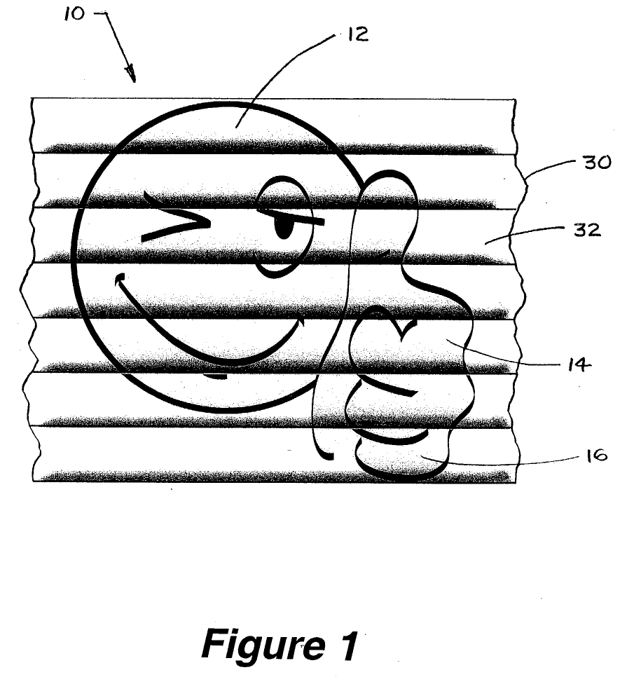

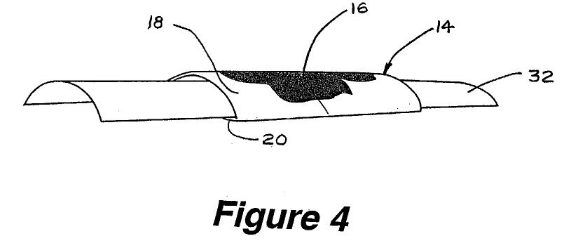

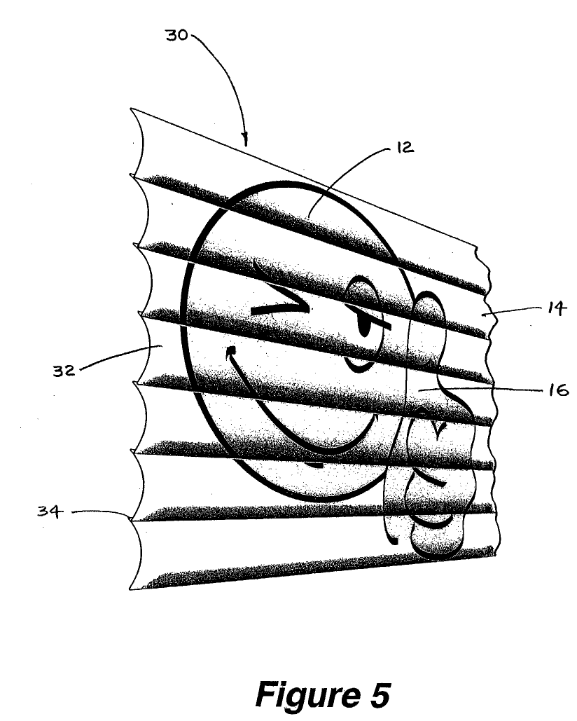

Referring to FIGS. 1-6 in general, and to FIG. 1 specifically, a blind covering kit in accordance with the present invention is shown and designated generally as 10. The kit 10 may be used on a variety of blinds, such as horizontal or vertical blinds. In FIG. 1, the kit 10 is shown installed on a Venetian blind 30 with horizontal slats 32. The kit 10 may be attached to a blind to display indicia, such as indicia incorporating a photograph, image or text when the slats are pivoted to a closed position. In FIG. 1, the kit 10 is shown displaying an image 12 that is visible when the slats 32 are closed.

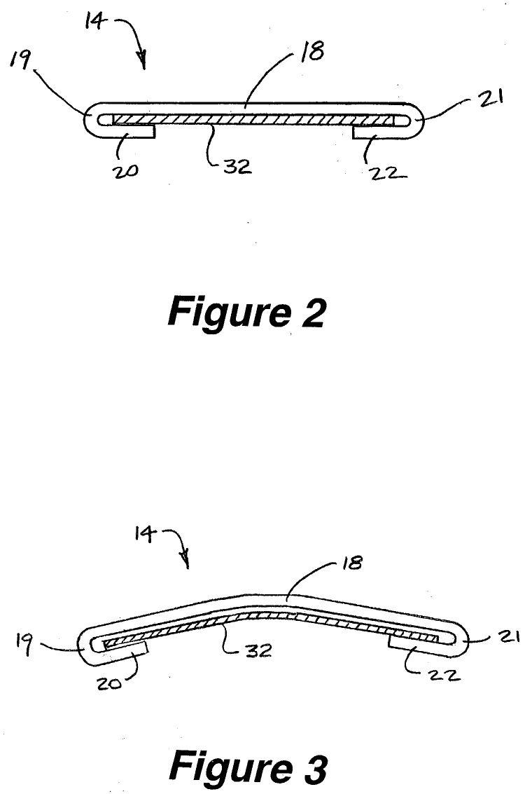

Referring now to FIGS. 1-3, the kit 10 comprises a plurality of strips 14, with each strip bearing a section 16 of the image 12. One or more tabs may be used to secure the strips 14 to the slats 32. In FIG. 2, a strip 14 is shown with a substantially flat central portion 18, a first edge 19, and a second edge 21. An upper tab 20 extends from the first edge 19 of the central portion 18, and a lower tab 22 extends from the second edge 20 of the central portion. The strip 14 is configured to be placed over the face of a slat 32, with the upper and lower tabs 20, 22 folded around the edges of the slat.

The strips 14 are preferably formed using a resilient flexible material, such as a 7 mil clear plastic film. This material allows the strips to bend or deform under stress and promptly return to their prestressed shape. The strips 14 are configured to clip or snap over the slats 32. More specifically, the upper tab 20 of the strip 14 is configured to hook over the top edge of a slat 32, and the lower tab 22 of the strip 14 is configured to snap around the bottom edge of the slat. The flexibility of the strips 14 allow them to clip around slats 32 having different widths and curvatures. In FIG. 2, the strip 14 is clipped around a slat 32 having a substantially flat shape. In FIG. 3, the strip 14 is clipped around the convex face of a curved slat. Preferably, the width of the central portion 18 of each strip 14 is between 1″ and 1⅛″, which can accommodate a variety of commercially available blinds. The width of the strips 14 is not a critical aspect of the invention, and other widths outside of the preferred range may be used within the scope of the invention.

The strips 14 are configured to align with one another on adjacent slats 32 and convey a substantially continuous and uninterrupted design 12 when the slats are closed. The central portion 18 of each strip 14 contains a component of the indicia, such as a section of an image or a component of a text or of a design. In FIG. 1, the central portion 18 of each strip 14 contains a section 16 of image 12. Each image section 16 may be aligned with image sections on adjacent strips to form the complete image 12.

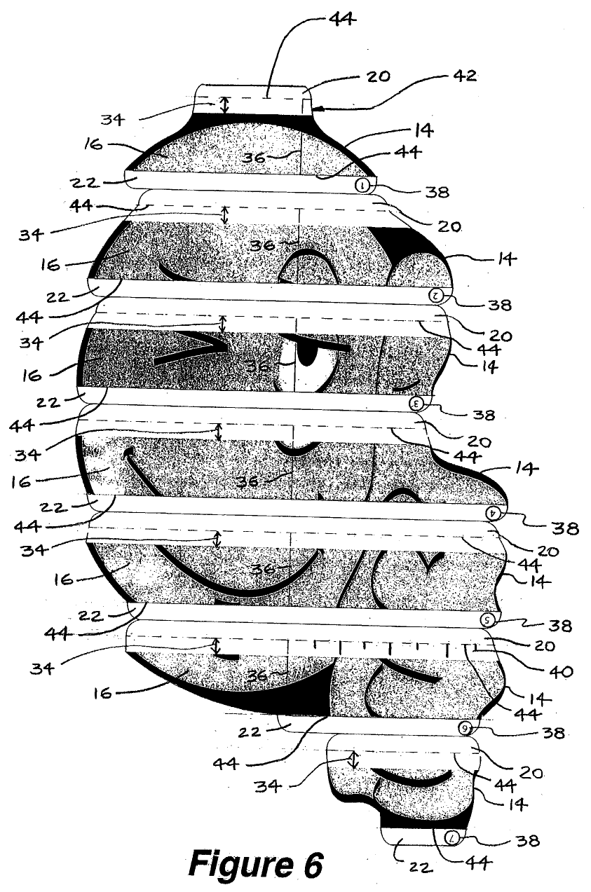

Typically, the slats 32 on the blind 30 will overlap when they are pivoted to a closed position. On most slats 32, the overlap causes an edge to be covered and hidden from view when the slats are closed. In FIG. 6, the top edges of all but the top slat are covered by adjacent slats. As a result, the front faces on most of the slats are partially covered. If images were formed on the entire center portion 18 of the strips 14, the overlap between slats would cover portions of the image sections, creating an interrupted image. To account for overlap, the image sections 16 are preferably placed beneath a margin 34 along the top edge of the strips 14. The width of the margin 34 is generally equal to the amount of overlap between adjacent slats 32 when the blind 30 is closed. In this way, the margins 34 on the strips 14 are overlapped by adjacent slats, and the image sections are not cut off by the overlapping slats. Referring to FIG. 6, a series of strips 14 are shown with margins 34 along the top edges of the strips.

The strips 14 are configured to slide laterally along the slats 32 once they are installed. In this way, the position of each strip 14 can be adjusted and aligned on the slat 32 to properly form the image 12. The strips 14 may be aligned by one or more markings printed on the strips. In FIG. 7, a faint vertical line 36 is printed on each strip 14. As will be discussed below, vertical lines 36 are preferably printed on each strip 14 where the strip will cover the center line of the blind. The strips 14 may be clipped on the slats 32 and aligned with one another by sliding the strips laterally so that the vertical lines 36 are aligned with one another. A numbering system may also be used to assist in installing the strips in the proper order to form the image 12. FIG. 6 shows a series of reference numbers 38 printed on the lower tab 22 of each strip. The reference numbers 38 are assigned to particular strips 14 based on the relative position or order of each image section 16 in the image 12. The strips 14 can be attached to the blind 30 by sorting the strips based on their reference number 38 and then installing them on the blind so that the strips are arranged in numerical order.

A method for making and installing a blind covering kit 10 will now be described. First, the type of blind is selected and measured to determine the dimensions of templates to be used for the strips. Where Venetian blinds are selected, the width of the slats are measured, and the amount of overlap between slats is determined. Once the measurements are taken, the photograph, image or text to be displayed on the blind is divided into sections and placed onto a series of templates. FIG. 6 illustrates a series of templates containing sections of the image 12. The image 12 is divided so that each image section 16 has a width equal to the width of the slats on the blind, minus the width of the overlap between slats.

The templates may be drawn or printed using a variety of methods, such as manual drafting or using computer software. A margin 34 is drawn on the templates above the top of each image section 16. The width of the margin 34 corresponds to the measured overlap between adjacent slats on the blind. For many blinds, the overlap between slats requires a margin width between ⅛″ and ¼″. If desired, a vertical guide line 36 and ruler markings 40 may be printed on each strip 14. The upper tab 20 is drawn above the margin 34, and the lower tab 22 is drawn below the bottom edge of the image section 16. Upper and lower tabs 20,22 having widths of approximately 7/32″ are sufficient to support a strip 14 having a central portion width between ⅛″ and ¼″.

Once the templates are drawn, the templates are reproduced and cut to form the strips 14. The strips 14 may be produced using a variety of printing methods and print media. In the preferred method, the templates are printed in full color on a jet printer that accepts 7 mil plastic film. It may be desirable to use a clear plastic film and print reverse images on the rear side of the film. In this way, the indicia are disposed on the inside of the strips 14 when the strips are clipped over the blind, protecting the indicia against scratching or fading.

The templates may be printed and cut simultaneously by the printer if the printer has that capability. The strips 14 are cut from the templates along the outline of each strip, as shown by the cut lines 42 in FIG. 6. Once the strips 14 are cut, the upper and lower tabs 20, 22 are pressed or folded back along fold lines 44 to a bent position with respect to the central portion 18. The upper tabs 20 are folded above the margins 34. The tabs 20, 22 may be formed by a variety of processes. For example, the strips 14 may be placed in a mechanical press that folds the tabs 20, 22 or the strips may be bent in an extrusion process. Once the tabs 20, 22 are folded, heat is applied to set the tabs so that the tabs remain in the folded position. Preferably, the tabs 20, 22 are folded back through an angle of approximately 180 degrees and set to the position similar to that shown in FIG. 2.

In many blinds, the strips 14 will intersect or come in contact with vertical strings and cords that operate and support the blind. The strips 14 can be fed through ladder-type strings that hang around the slats 32. Where draw strings penetrate through the slats 32, one or more holes are formed in the strips 14 to permit the strips to fit around the draw strings. The strips 14 may be hole-punched or slotted to allow the strips to fit around the draw strings. An optional tool, such as a hole puncher, may be provided with the kit 10 to form holes or slots for this purpose.

The position of the hole punches on each strip may be determined by measuring the distance between the center of the slat 32 and the draw string that penetrates through the slat. A center line 36 is marked on each strip 14 at a position which will cover the center of a slat when the strip is placed over the slat. The correct position for the hole punch is marked on the strip 14 by placing a mark at a distance from the center line 36 corresponding to the distance between the center of the slat 32 and the draw string. Referring to FIG. 6, ruler markings 40 are printed along the top margin 34 of one of the strips 14. The ruler markings 40 allow one to measure the position of hole punches relative to the center line 36 of the design section 16. It is noted that ruler markings 40 may be provided on every strip 14, but are shown on only one strip in FIG. 6 for clarity. Since the margin 34 will be covered by an overlapping slat, the ruler markings 40 are not visible when the strips 14 are viewed on the blind 30 with the slats 32 closed. The ruler markings 40 may also be printed on one or both of the tabs 20,22, as the tabs will not be visible when the strips are viewed on the blind.

The terms and expressions which have been employed are used as terms of description and not of limitation. There is no intention in the use of such terms and expressions of excluding any equivalents of the features shown and described or portions thereof. It is recognized, therefore, that various modifications are possible within the scope and spirit of the invention. Accordingly, the invention incorporates variations that fall within the scope of the following claims.

I claim:

1. A decorative system for attachment to a Venetian blind installation having a plurality of slats, said system comprising a plurality of resilient flexible strips, each strip configured for attachment over a slat and bearing an indicia comprising a component of an integrated design, said strips adapted to clip over the slats and visibly convey the design components in a substantially continuous arrangement that cumulatively convey the integrated design.

2. A decorative system for attachment to a Venetian blind installation having a plurality of slats operable in an open position and a closed position, said system comprising a plurality of resilient flexible strips, each strip having a central portion, a folded back top flap and a folded back bottom flap, the central portion of each strip bearing an indicia comprising one component of a design, a text or an image, said top flap and said bottom flap of each strip configured to detachably secure the strip to a slat on the blind, and said plurality of strips configured to attach to adjacent slats on the blind such that, when the slats are in the closed position, the top and bottom flaps are hidden, and the indicia on each central portion are visible and align in a coordinated fashion to convey one of an image, a text and a design.

3. A decorative system for attachment to a Venetian blind installation having a plurality of slats pivotal between an open position, in which the slats are non-overlapping, and a closed position, in which the slats are overlapping, said decorative system comprising a plurality of resilient flexible strips, each strip having a central portion and a pair of flaps for securing the strip to a slat, the central portion of each strip bearing an indicia section and a margin section adjacent to the indicia section, said margin section having a width generally equal to the width of overlap between adjacent slats when the slats are in the closed position, said plurality of strips configured to attach to adjacent slats on the blind such that, when the slats are in the closed position, the indicia sections are exposed and aligned in a substantially uninterrupted arrangement to convey one display of an image, a text and a design, and the margin sections are covered by the overlap between adjacent slats.

4. A method for making a covering kit for attachment over the slats on a blind, comprising the steps of:
dividing a photograph, block of text or visual image into a series of components, with each component having a predetermined width;
forming a template that incorporates the image components into a plurality of strips;
reproducing the template onto a sheet material;
cutting and separating the strips from the sheet material;
attaching the strips over the face of slats on a blind in a coordinated arrangement to display the photograph, block of text or visual image on the blind.

5. The method of claim 4 wherein the step of forming a template comprises delineating a tab adjacent to each image component on the sheet material, said tabs being cut with the image components to form the strips, and said tabs being configured to clip over the slats on a blind to secure the strips to the blind.

6. The method of claim 4, further comprising the step of cutting one or more apertures at predetermined locations on each strip to permit the strip to be installed around one or more strings on the blind.
